(19) United States
(12) Patent Application Publication
(10) Pub. No.: US 2008/0021935 A1
(43) Pub. Date: Jan. 24, 2008

(54) System and Method for Avoiding Redundant Copying of Shared Content When Using Virtual Titles

(75) Inventors: Josephus Joannes Mathijs Maria Geelen, Susteren (NL); Natarajan Ganapathy Subramanian, Eindhoven (NL); Marcel Van Nieuwenhoven, Eindhoven (NL); Jacobus Wilhelmus Gerardus Welton, Asten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,995

(22) PCT Filed: Sep. 9, 2005
(86) PCT No.: PCT/IB05/52959

§ 371 Date: Mar. 9, 2007

Related U.S. Application Data
(60) Provisional application No. 60/609,091, filed on Sep. 10, 2004.

(51) Int. Cl. G06F 7/22

(52) U.S. Cl. 707/203

(57) ABSTRACT

A virtual title copying system and method that prevents redundant copying of content from a source medium to a destination medium during a copy transaction. Included is a system (24) that determines if a content section to be copied has an associated copy transaction identifier (30) at the source (12) and destination (16) medium; and a system (26) that generates and assigns a new copy transaction identifier to the source and destination medium during the copy transaction if no copy transaction identifier exists at the source and destination medium.

The present invention relates generally to systems that utilize virtual titles to reference audio visual content, and more specifically relates to a system and method for avoiding redundant copying of content when using virtual titles.

The copying of audio visual content from a source medium (e.g., hard drive) to a destination medium (e.g., optical disc) is a common practice. Certain devices that provide this functionality rely on virtual titles (VTs) that act as pointers to pieces of the content being copied or played back. A virtual title is generally defined as a collection of ordered playing intervals, where each play interval is a reference to a complete or part of an audio video stream or file. Thus, by instructing the device to copy a virtual title (e.g., scene 1) to a destination medium, the virtual title points to the actual content, which can then be copied.

One of the problems with using virtual titles in this manner is that multiple virtual titles may point to the same, or portions of the same, content. That is, there may be content used by more than one virtual title. When this occurs, the shared content may be copied multiple times, especially when virtual titles are copied separately over time. The result is both a waste of computational and storage resources.

When, for example, audio visual (AV) content is copied from a hard disc drive (HDD) to a recordable removable disc (RRMD), the AV content on the RRMD will be associated with a new identifier (e.g., Title Number) that will depend on the standard used by the RRMD. Thus, the content to be copied has two presentations, one that is associated with the content on the HDD side, and one that is associated with the content on the RRMD side. At the time of the copying, there exists a relationship between the two presentations. However, after the copying is complete (i.e., the disc is ejected), the relationship is lost, and there is no way of determining where the content on the RRMD originated from. Thus, when two or more VTs share (i.e., point to) the same content or audio visual title (AVT), and two or more separate copying operations take place to the same RRMD, the shared AV content gets recopied during each copying operation on the RRMD.

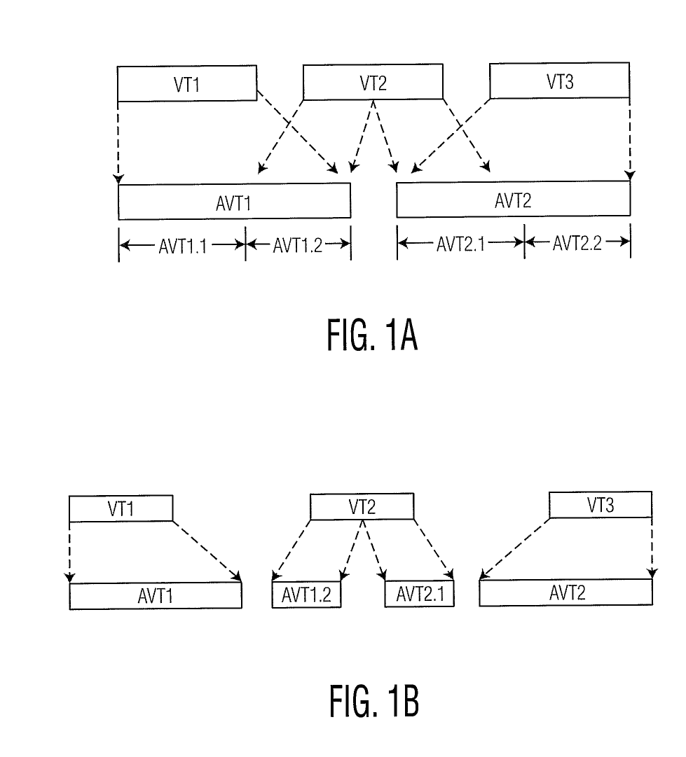

The problem is shown in detail in FIGS. 1A and 1B where there are three VTs (VT1, VT2, and VT3) that share two AVTs (AVT1 and AVT2). In particular, as shown in FIG. 1A, AVT1 is shared by both VTI and VT2 and AVT2 is shared by both VT2 and VT3. Then, after copying, as shown in FIG. 1B, a portion of AVT1 (i.e., AVT1.2) and a portion of AVT2 (i.e., AVT2.1) are copied twice.

Accordingly, a need exists for a system and method that will avoid the redundant copying of shared content when using virtual titles.

The present invention addresses the above-mentioned problems, as well as others, by providing a system and method for avoiding redundant copying of shared content when using virtual titles by tracking each copy transaction on both the source and destination medium utilizing a unique identifier. In a first aspect, the invention provides a virtual title copying system that prevents redundant copying of content from a source medium to a destination medium during a copy transaction, comprising: a system that determines if a content section to be copied has an associated copy transaction identifier at the source and destination medium; and a system that generates and assigns a new copy transaction identifier to the source and destination medium during the copy transaction if no copy transaction identifier exists at the source and destination medium.

In a second aspect, the invention provides a virtual title copying method that prevents redundant copying of content from a source medium to a destination medium, comprising: initiating a copy of a virtual title that points to a content section on the source medium; determining if the content section has an associated copy transaction identifier at the source and destination medium; if the associated copy transaction identifier does not exist at the source and destination medium prior to the copy transaction, then: copying the virtual title and content section to the destination medium; and generating and assigning a new copy transaction identifier to the content section at the source and destination medium; and if the associated copy transaction identifier does exist at the source and destination medium, then: creating the virtual title at the destination medium to reference an existing content section at the destination medium associated with the existing copy transaction identifier.

In a third aspect, the invention provides a program product stored on a recordable medium that prevents redundant copying of content from a source medium to a destination medium during a copy transaction, comprising: means for determining if a content section to be copied has an associated copy transaction identifier at the source and destination medium; and means for generating and assigning a new copy transaction identifier to the source and destination medium during the copy transaction if no copy transaction identifier exists at the source and destination medium prior to the copy transaction.

These and other features of this invention will be more readily understood from the following detailed description of the various aspects of the invention taken in conjunction with the accompanying drawings in which:

FIG. 1A depicts a set of virtual titles and associated AV titles prior to copying.

FIG. 1B depicts the set of virtual titles and associated AV titles after copying using prior art technology.

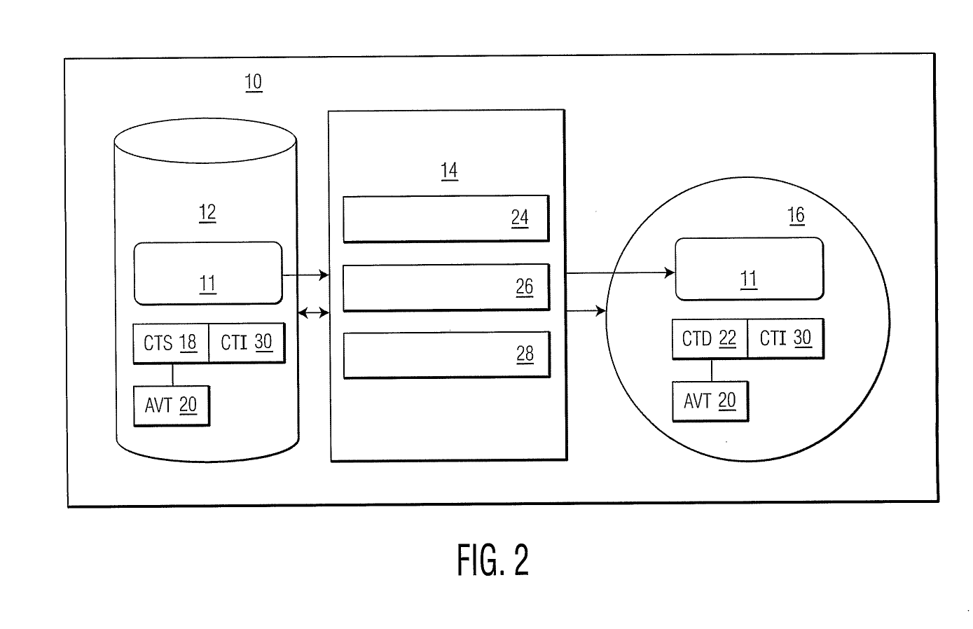

FIG. 2 depicts an AV archive system in accordance with an embodiment of the present invention.

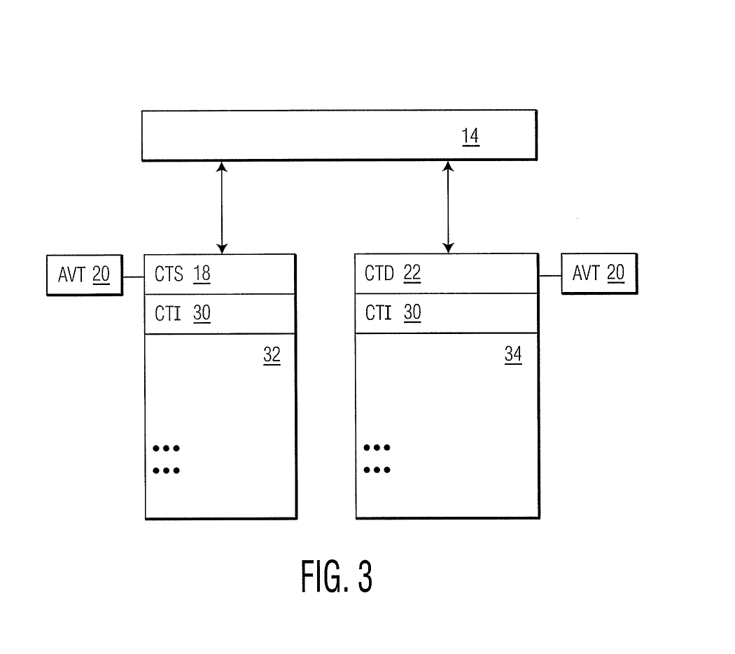

FIG. 3 depicts a copy transaction source file and an associated copy transaction destination file in accordance with an embodiment of the present invention.

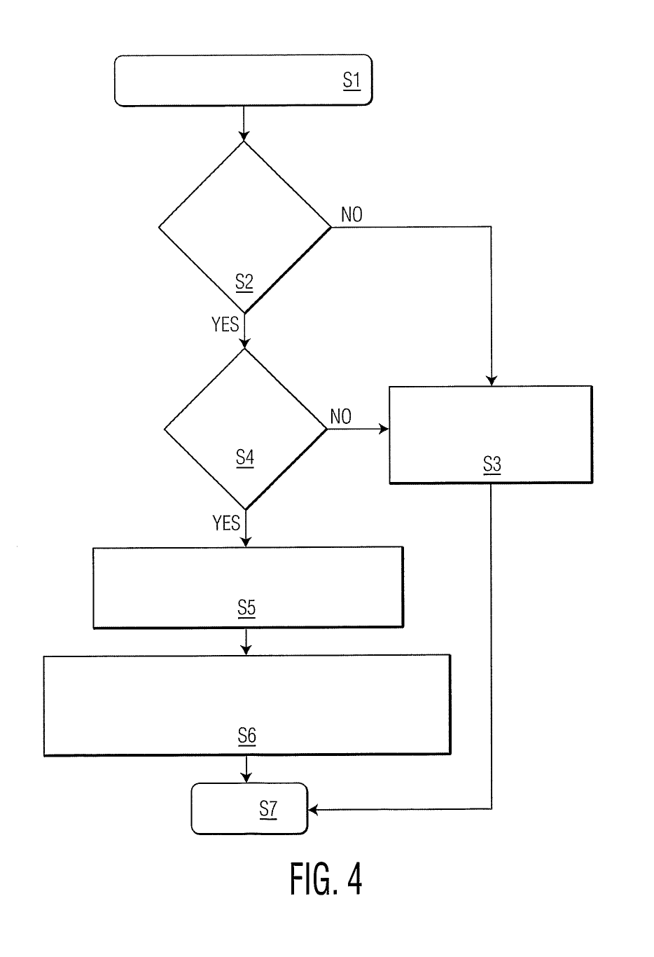

FIG. 4 depicts a flow chart of a method of implementing a copy transaction manager in accordance with an embodiment of the present invention.

Referring now to FIG. 2, a virtual title (VT) copying system 10 is shown that includes a copy transaction manager 14 for copying content specified by one or more virtual title(s) 11. Each specified virtual title 11 refers or points to a content section on the source medium 12. In this illustrative example, copy transaction manager 14 copies a content section, referred to herein as audio video title content (AVT) 20, from a source medium 12, e.g., a hard disc drive (HDD) 12, to a destination medium 16, e.g., a recordable removable medium (RRMD) such as an optical disc. AVT 20 comprises sections of recorded AV content, e.g., a chapter, a scene, etc. When copying data from source to destination, one or more AVTs 20, or portions of an AVT, are referenced using virtual titles. For instance, a virtual title might comprise a simple title, such as “Chapter 1,” or “Scene 3,” or could include a name such as “Frames xx-yy.” Note that while the present invention is described with reference to copying/archiving AV content, the inventive techniques described herein could be applied to other types of content copying/archiving without departing from the scope of the invention. It should also be understood that the present invention can be utilized to copy content from and to any type of medium that can be written to, e.g., magnetic media, optical media, a media card, RAM, ROM, etc.

As noted above, it is possible that two different VTs can point to the same AVT 20. Copy transaction manager 14 prevents multiple or redundant copies of AVTs from being copied to the destination medium 16 when this situation occurs. To achieve this, copy transaction manager 14 first looks on both the source and destination medium for copy transaction (CT) data associated with the AVT 20 to be copied. If a match exists for the AVT 20 to be copied, then no actual copying of the AVT 20 is required. Instead, the virtual title 11 created on the destination medium 16 during the copy operation simply references the existing AVT 20. If no matching CT data exists for the AVT 20 to be copied, then copy transaction manager 14 copies the AVT 20 to the destination medium 16, and records the CT data on both the source and destination medium for future reference.

As shown in more detail in FIG. 3, for a given AVT 20, CT data has two components, a CTS record 18 which resides at the source medium 12, and a CTD record 22 which resides at the destination medium 16 (See, FIG. 3). Both components share the same unique identifier, CTI 30. CTI 30 is a globally unique identifier generated by the copy transaction manager 14 when copying a particular piece of AVT content. Thus, each AVT 20 can be identified with its own globally unique CTI 30. Any method for generating a unique identifier may be utilized. For instance, CTI 30 may comprise a sequence of bytes including a number describing the copying device, a serial number for the copying device, transaction date and time information, and a random number.

Referring back to FIG. 2, copy transaction manager 14 includes a checking system 24 for checking for CT identifiers (CTIs) when a copy operation is initiated to copy AVT 20 or set of AVTs. As noted above, each CT identifier is stored within a CTS record 18 on the source medium 12 and within a CTD record 22 on the destination medium 16. For each AVT 20 to be copied, checking system 24 determines if there is a CT identifier associated with the AVT at the source medium 12. If a CT identifier 30 exists, then checking system 24 will determine if the same CT identifier 30 exists on the destination medium 16. If the same CT identifier 30 does exist on the destination medium 16, then the copy transaction manager 14 knows that there is no need to copy the AVT 20. Instead, the virtual title 11 copied to the destination medium 16 can be made to simply point to or reference the existing AVT 20 on the destination medium 16.

If no matching CT identifiers exist between the source medium 12 and destination medium 16, then generating system 26 creates and assigns a new CTS 18 with a unique CT identifier 30 for the source medium 12 and a new CTD 22 with the same unique identifier 22 for the destination medium 16. Copy transaction manager 14 may also include a deletion system 28 for deleting CTS records 18 and CTD records 22 from the respective medium when the associated AVT 20 is deleted there from. Referring again to FIG. 3, both CTS record 18 and CTD record 22 include source identifiers 32 and destination identifiers 34, respectively. These identifiers hold information from the source and destination mediums about the “presentation” of the AVT content 20 that was copied, e.g., start and end positions of the AV and metadata content on their respective mediums.

FIG. 4 depicts a flow diagram of an illustrative method of implementing the invention. At step S1, the process of copying a virtual title from a source medium to a destination medium is initiated. This generally involves listing the virtual title on destination medium with a pointer to the associated AVT 20. At step S2, a determination is made whether the content to copy is associated with a CTS record 18 at the source medium 12. If there is no association, all the content is copied to the destination medium and new CTS-CTD pairs are assigned and stored at step S3. If an association exists at step S2, then a determination is made at step S4 whether there exists any matching CTS-CTD pairs at the source and destination. If no matches exist at step S4, then all the content is copied to the destination medium and new CTS-CTD pairs are assigned and stored at step S3. If a match is found at step S4, then at step S5, for each matching CTS-CTD pair, a reference (i.e., pointer) to the existing content at the destination medium 16 is utilized and no copying is required. Then at step S6, for non-matching pairs or non-existing CTDs, the corresponding content is copied and new CTS-CTD pairs are assigned and stored. The process then ends at step S7.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A virtual title copying system (10) that prevents redundant copying of content from a source medium (12) to a destination medium (16) during a copy transaction, comprising:
a system (24) that determines if a content section to be copied has an associated copy transaction identifier (30) at the source and destination medium; and
a system (26) that generates and assigns a new copy transaction identifier to the source and destination medium during the copy transaction if no copy transaction identifier exists at the source and destination medium.

2. The virtual title copying system of claim 1, further comprising a system that provides a virtual title (11) on the destination medium that points to an existing content section at the destination medium if the associated copy transaction identifier exists at the source and destination medium for the content section.

3. The virtual title copying system of claim 1, further comprising a system (28) for deleting the copy transaction identifier.

4. The virtual title copying system of claim 1, wherein the source medium and destination medium are selected from the group consisting of: a hard disc drive, an optical disc, a media card, and an Internet connection.

5. The virtual title copying system of claim 1, wherein the copy transaction identifier is stored:
in a first record at the source medium that includes start and end position data for the content section on the source medium; and
in a second record at the destination medium that includes start and end position data for the content section on the destination medium.

6. The virtual title copying system of claim 1, wherein the copy transaction identifier is unique for the content section being copied.

7. The virtual title copying system of claim 1, wherein the copy transaction identifier comprises a sequence of bytes that includes a serial number for a copying device, a transaction date and time, and a random number.

8. A virtual title copying method that prevents redundant copying of content from a source medium (12) to a destination medium (16), comprising:
initiating a copy of a virtual title (11) that points to a content section on the source medium;
determining if the content section has an associated copy transaction identifier (3) at the source and destination medium;
if the associated copy transaction identifier does not exist at the source and destination medium prior to the copy transaction, then:
copying the virtual title and content section to the destination medium; and
generating and assigning a new copy transaction identifier to the content section at the source and destination medium; and
if the associated copy transaction identifier does exist at the source and destination medium, then:
creating the virtual title at the destination medium to reference an existing content section at the destination medium associated with the existing copy transaction identifier.

9. The method of claim 8, wherein the source medium and destination medium are selected from the group consisting of: a hard disc drive, an optical disc, a media card, and an Internet connection.

10. The method of claim 8, wherein the copy transaction identifier is stored:
in a first record at the source medium that includes start and end position data for the content section on the source medium; and
in a second record at the destination medium that includes start and end position data for the content section on the destination medium.

11. The method of claim 8, wherein the copy transaction identifier is unique for the content section being copied.

12. The method of claim 8, wherein the copy transaction identifier comprises a sequence of bytes that includes a serial number for a copying device, a transaction date and time, and a random number.

13. A program product stored on a recordable medium that prevents redundant copying of content from a source medium (12) to a destination medium (16) during a copy transaction, comprising:
means (24) for determining if a content section to be copied has an associated copy transaction identifier (30) at the source and destination medium; and
means (26) for generating and assigning a new copy transaction identifier to the source and destination medium during the copy transaction if no copy transaction identifier exists at the source and destination medium prior to the copy transaction.

14. The program product of claim 13, further comprising means for providing a virtual title on the destination medium that points to an existing content section at the destination medium if the associated copy transaction identifier exists at the source and destination medium for an existing content section.

15. The program product of claim 13, further comprising means for copying the content section to the destination medium if the associated copy transaction identifier does not exist at the source and destination medium for an existing content section.

16. The program product of claim 13, further comprising a system for deleting the copy transaction identifier.

17. The program product of claim 13, wherein the source medium and destination medium are selected from the group consisting of: a hard disc drive, an optical disc, a media card, and an Internet connection.

18. The program product of claim 13, wherein the copy transaction identifier is stored:
in a first record at the source medium that includes start and end position data for the content section on the source medium; and
in a second record at the destination medium that includes start and end position data for the content section on the destination medium.

19. The program product of claim 13, wherein the copy transaction identifier is unique for content section being copied.

20. The program product of claim 13, wherein the copy transaction identifier comprises a sequence of bytes that includes a serial number for a copying device, a transaction date and time, and a random number.
